(19) United States
(12) Patent Application Publication
(10) Pub. No.: US 2014/0285472 A1
(43) Pub. Date: Sep. 25, 2014

(54) SENSOR AND INPUT DEVICE SUCH AS A TOUCH SCREEN INCLUDING SUCH A SENSOR, DISPLAY DEVICE AND METHOD

(71) Applicant: STMicroelectronics (Research & Development) Limited, Marlow (GB)

(72) Inventor: Jeff Raynor, Edinburgh (GB)

(73) Assignee: STMicroelectronics (Research & Development) Limited, Marlow (GB)

(21) Appl. No.: 14/220,948

(22) Filed: Mar. 20, 2014

(30) Foreign Application Priority Data
Mar. 22, 2013 (GB) 1305288.1

(51) Int. Cl. G06F 3/042

(52) U.S. Cl. CPC G06F 3/042
USPC 345/175

(57) ABSTRACT

A sensor includes a linear array of sensitive photodetectors each forming part of an associated pixel circuit. The pixel circuits accumulate photo-generated charge from their photodetectors simultaneously but with different gains for different pixels. Each pixel circuit comprises an operational amplifier arranged to integrate a photocurrent received from the photodetector over a sampling interval that is substantially the same for all pixels. The gain of each pixel circuit is made variable over time by switching one or more capacitors in and out of the integrating circuit. In one embodiment a gain selection signal is written into each pixel circuit during a data read-out cycle. In another embodiment, the gain of each pixel varies automatically in response to data obtained from the pixel in a previous cycle. Several similar sensors are used to detect touch positions in a touch screen input device.

### BACKGROUND

1. Technical Field

The present disclosure relates to a sensor and input device incorporating one or more such sensors. The input device may be particularly but not exclusively for an optical touch screen. The disclosure further relates to input devices and a touch screen apparatus including such sensors.

2. Description of the Related Art

In current day optical touch screen sensors there is a broad range of illumination levels on the pixel due to the different path lengths of impinging light beams. For example, the center of the sensor may image a remote area of the screen which is far away from the sensor and illumination source resulting in a low light level on the relevant pixels. Similarly, the edges of the sensor may image areas closer to the sensor and illumination source and the pixels will then have a higher level of light impinging thereon.

Use of an automatic exposure system may increase the light level to ensure that the brightest part of the scene is near a maximum, but not at the maximum. The light levels can be adjusted by either varying the current into a light emitting diode (LED) or the like, or by adjusting the exposure time of the sensor. The darkest parts of the scene will tend to give rise to less light on the sensor and therefore be more susceptible to noise.

As screen sizes increase, the differences in the illumination levels across the screen become proportionally larger and this becomes more of a problem. Typically, the design of the sensor is optimized for noise and so if the dynamic range of the scene increases, then the signal to noise ratio (SNR) at the darker part of the scene will inevitably be degraded. This can often lead to degradation of the overall system performance. In a touch-screen system, a possible result is a false generation of a touch signal which could lead to very unfortunate consequences, such as losing files or worse. Accordingly, there is a requirement to increase the intra-scene dynamic range of a linear sensor.

One such way to address this problem is the use of logarithmic pixels. A common technique is to use a transistor in sub-threshold mode where the voltage drop across the source/drain is logarithmically dependent on the source voltage. This can increase the intra-scene dynamic range. However, there are numerous problems with this technique. One problem is the effect of lag in which the pixels are slow to react to a dark/light change. This can cause problems in all types of systems, but is particularly problematic for touch screens. A second problem is the problem of matching, where the response of the pixels is dependent on the performance of the sub threshold transistors. This can vary greatly between adjacent pixels and also as a result of changes in temperature. A further problem is issue of noise. As the logarithmic pixels do not “integrate” or collect electrons, the output becomes dependent on the instantaneous current level and tends to exhibit more noise.

A further proposal relates to a high dynamic range technique. With traditional sensors, the reset transistor of the pixel is controlled by a digital signal and therefore the pixel is either integrating or in reset. This high dynamic range technique applies an analogue voltage to the reset transistor of the pixel which allows it to switch automatically between integrating and reset mode, depending on both the reset voltage and light level.

This technique is effective, but not well suitable for a linear sensor, as the integration time is a function of the light level which means different regions of the sensor will be collecting light at different times. For a touch screen system it is important to capture motion or temporal variation accurately and any temporal fidelity is lost if different integration times are used.

In a further proposal a wide dynamic range system has been suggested. This uses a technique called “pixel skimming” which allows a single pixel to capture and measure light over long and short periods simultaneously. For low light levels a long period is used and for high light levels a short period is used.

This is an effective technique, but the skimming procedure relies on varying the potential of a “transfer gate” transistor to “skim” the charge from the light sensitive area into a voltage sensitive node. This transfer-gate type of operation is restricted to small areas of typically less than 3 μm×3 μm pixels. This is due to the fact that the pixel must have special implants which generate electric fields to ensure that all the electrons flow from the light sensitive area (photodiode) to the voltage sensitive node. (Normally charge is only shared between the two parts of the device, so that a portion of the charge remains on the photodiode.) In the event of lag on the transfer operation where not all the electrons are transferred in a given period, they could be transferred on the next transfer period of the pixel and hence result in temporal noise. For a touch screen the typical pixel sizes of a linear sensor are much larger, such as 5 μm-10 μm (X)×10-50 μm (Y), and temporal noise is unacceptable. From above, it can be seen that neither transfer gate nor pixel skimming techniques are practical in touch screens.

Typically, pixels all have the same length of exposure time, also referred to as “shutter” or “integration” time, so they will all produce the same output for the same light level.

US20060066750 proposes having multiple exposures on an array. The technique is effective, but not well suited for a linear sensor as the integration time is a function of the light level and as a result different regions of the sensor will be collecting light at different times. As previously indicated it is important to capture motion or temporal variation accurately in a touch screen environment. If different integration times are used there is a loss of temporal fidelity, which is not suitable for touch screens.

It may also be noted that it is known to adjust the conversion gain of pixels in accordance with light levels seen in each part of an image as part of the read-out process. Examples of circuits with this feature are disclosed for example in published patent applications US20130048831, US 20120188427, US 20040251394 and US 20120273651.

From the above, it can be seen that there are still a number of problems that have not yet been solved and addressed by the prior art.

### BRIEF SUMMARY

According to an embodiment of the present disclosure there is provided a sensor comprising an array of light-sensitive photodetectors each forming a pixel as part of an associated pixel circuit, wherein the pixel circuits are operable to accumulate photo-generated charge from said photodetectors substantially simultaneously but with different gains for different pixels.

In an embodiment, each pixel circuit comprises an integrator arranged to integrate a photocurrent received from said photodetector over a sampling interval that is substantially the same for all pixels, the different gains of different pixel circuits being implemented by differences in a capacitance within said integrator. The gain of each pixel circuit can be made variable over time, if desired, for example by switching one or more capacitors in and out of an integrating circuit.

In an embodiment where pixel output signals are read out from the pixel circuits in a read cycle using an address bus and a data bus, wherein a gain selection signal may be written into each pixel circuit as part of a data read-out cycle. Alternatively the gain selection may be performed separately from data readout.

In some embodiments, a gain used signal is read out of each pixel circuit as part of a data read-out cycle. In some embodiments, the gain of each pixel may be varied automatically in response to data obtained from the pixel in one or more previous operations.

The sensor may further comprise a scaling function for converting data from all pixel circuits to a common scale.

The present disclosure in some embodiments provides methods of operating sensors of the type set forth above, including steps of adjusting pixel gains prior to capturing image signals, and/or steps of updating pixel gains automatically in response to detected illumination levels.

According to some embodiments of the disclosure there is provided an input device including at least one sensor as set forth herein, an illumination source arranged to illuminate the sensor via a medium to be monitored, and a processor arranged to calculate object position information using image data provided by the sensor. The device may for example be provided in the form of a touch panel, said medium comprising a transparent touch panel, the input device being for sensing the position of a user's touch on the panel using illumination provided from an edge of the panel.

In some embodiments, an input device comprises a plurality of similar sensors viewing the medium from different directions, the processor being arranged to combine views from the different detectors to obtain a single position.

The device may be used in a telephone, a computer, a biometric sensor or any other appropriate device. The touch panel may be combined with a display arranged to be visible through the transparent touch panel.

The described sensors and devices offer a number of benefits, such as providing an effective, method to increase the dynamic range of a linear sensor. In an embodiment, a larger intra-scene dynamic range for large pixel sizes may be provided while still preserving temporal sampling accuracy by exposing the pixels simultaneously.

In an embodiment, a device comprises a plurality of pixels, each pixel including: a light-sensitive photodetector; and circuitry configured to set a pixel gain of the pixel and to accumulate photo-generated charge from the light sensitive photodetector, wherein the plurality of pixels are configured to accumulate photo-generated charge substantially simultaneously using different pixel gains for different pixels of the plurality. In an embodiment, a device comprises: a plurality of pixels, each pixel including: a light-sensitive photodetector; and circuitry configured to independently set a pixel gain of the pixel and to accumulate photo-generated charge from the light sensitive photodetector, wherein the plurality of pixels are configured to accumulate photo-generated charge substantially simultaneously using the respective independently set pixel gains.

In an embodiment, each pixel comprises an integrator to integrate a photocurrent received from said photodetector over a sampling interval that is substantially the same in the pixels of the plurality, the setting of the respective pixel gains of the pixels of the plurality being implemented by selecting a capacitance within said integrator. In an embodiment, the pixel gain of a pixel of the plurality is variable over time. In an embodiment, circuitry of a pixel of the plurality is configured to set the pixel gain by switching one or more capacitors in and out of an integrating circuit. In an embodiment, a pixel of the plurality is coupled to an address bus and a data bus and is configured to, in a data read-out cycle: provide a pixel output signal; and store a pixel gain selection signal. In an embodiment, pixel output signals are read out from the pixels in a read cycle using an address bus and a data bus, and a gain-used signal is read out of each pixel as part of the read cycle. In an embodiment, the device is configured to select a gain of each pixel of the plurality automatically in response to data obtained from the respective pixel in one or more previous operations. In an embodiment, the device comprises a scaling module configured to convert data from the pixels of the plurality of pixels to a common scale. In an embodiment, said plurality of pixels are arranged in a linear array. In an embodiment, the gain of a subgroup of pixels of the plurality is set for the subgroup.

In an embodiment, a system comprises: a sensor; an illumination source configured to illuminate the sensor via a medium to be monitored; and a processor configured to generate object position information using image data provided by the sensor, the sensor including a plurality of pixels, each pixel having: a light-sensitive photodetector; and circuitry configured to set a pixel gain of the pixel and to accumulate photo-generated charge from the light sensitive photodetector, wherein the plurality of pixels are configured to accumulate photo-generated charge substantially simultaneously using different gains for different pixels of the plurality of pixels. In an embodiment, a system comprises: a sensor; an illumination source configured to illuminate the sensor via a medium to be monitored; and a processor configured to generate object position information using image data provided by the sensor, the sensor including a plurality of pixels, each pixel having: a light-sensitive photodetector; and circuitry configured to independently set a pixel gain of the pixel and to accumulate photo-generated charge from the light sensitive photodetector, wherein the plurality of pixels are configured to accumulate photo-generated charge substantially simultaneously using the respective independently set pixel gains.

In an embodiment, said medium comprises a transparent touch panel, the system being configured to sense, using illumination provided from an edge of the panel, a position of a touch to the panel. In an embodiment, the system comprises a plurality of sensors including the sensor, the plurality of sensors being configured to sense the medium from different directions, the processor being configured to combine signals from the plurality of sensors to generate the object position information. In an embodiment, the medium is a transparent touch panel of a display. In an embodiment, the display is a personal computer or communication device display. In an embodiment, the circuitry of a pixel of the plurality is configured to set the pixel gain of the pixel by switching one or more capacitors in and out of an integrating circuit of the circuitry.

In an embodiment, a method comprises: setting a pixel gain of each pixel of a plurality of pixels of a sensor, each pixel of the plurality including a light-sensitive photodetector and pixel circuitry configured to set the pixel gain of the pixel; and accumulating photo-generated charge from the light sensitive photodetectors of the plurality of pixels substantially simultaneously using the respective pixel circuitry and different pixel gains for different pixels of the plurality of pixels. In an embodiment, a method comprises: independently setting a pixel gain of each pixel of a plurality of pixels of a sensor, each pixel of the plurality including a light-sensitive photodetector and pixel circuitry configured to set the pixel gain of the pixel; and accumulating photo-generated charge from the light sensitive photodetectors of the plurality of pixels substantially simultaneously using the respective pixel circuitry and independently set pixel gains.

In an embodiment, the method comprises updating the pixel gains automatically in response to previously generated signals of the pixels. In an embodiment, the accumulating photo-generated charge in a pixel of the plurality comprises integrating in an integrator of the circuitry of the pixel a photocurrent received from the photodetector of the pixel over a sampling interval, the sampling interval having substantially a same duration in the pixels of the plurality; and setting the pixel gain of a pixel of the plurality comprises switching one or more capacitors in and out of the integrator. In an embodiment, a pixel of the plurality is coupled to an address bus and a data bus and the method includes, in a data read-out cycle: providing by the pixel circuitry of a pixel output signal; and storing of a pixel gain selection signal. In an embodiment, a gain-used signal is read out of each pixel as part of the data read-out cycle. In an embodiment, the method comprises converting data from the pixels of the plurality of pixels to a common scale. In an embodiment, said plurality of pixels are arranged in a linear array. In an embodiment, the method comprises: illuminating a medium of the sensor; and generating object position information using image data provided by the sensor. In an embodiment, said medium comprises a transparent touch panel, the position information is a position of a touch to the panel and the illumination is provided from an edge of the panel. In an embodiment, the method comprises: reading signals from the sensor and from one or more additional sensors, wherein the generated object position information is based on the signals read from the sensor and from the one or more additional sensors.

### BRIEF DESCRIPTION OF THE SEVERAL VIEWS OF THE DRAWINGS

Reference will now be made, by way of example, to the accompanying drawings, in which:

FIG. 1 is a schematic diagram of a touch screen input device using an array sensor according to an embodiment;

FIG. 2 is a schematic diagram of two representative pixel circuits from an array sensor in a known example;

FIG. 3 is a schematic diagram of modified pixel circuits in accordance with a first embodiment; and

FIG. 4 is an overall schematic block diagram of an array sensor according to the first embodiment;

FIG. 5 is a waveform diagram showing the timing of a gain setting operation in the array sensor of FIGS. 3 and 4;

FIG. 6 illustrates the varying of conversion gain with different capacitance values in pixel circuits such as those used in the embodiment of FIGS. 3 and 4;

FIG. 7 is a schematic diagram of a representative pixel circuit in a second embodiment;

FIGS. 8 and 9 are schematic diagrams of a scaling block in the first and second embodiments respectively;

FIG. 10 is a waveform diagram showing an example timing of data readout in the array sensors of FIGS. 3 to 9; and

FIG. 11 is a schematic diagram of two pixel circuits in a third embodiment.

### DETAILED DESCRIPTION

In the following description, certain details are set forth in order to provide a thorough understanding of various embodiments of devices, methods and articles. However, one of skill in the art will understand that other embodiments may be practiced without these details. In other instances, well-known structures and methods associated with, for example, signal processing devices, have not been shown or described in detail in some figures to avoid unnecessarily obscuring descriptions of the embodiments.

Unless the context requires otherwise, throughout the specification and claims which follow, the word “comprise” and variations thereof, such as “comprising,” and “comprises,” are to be construed in an open, inclusive sense, that is, as “including, but not limited to.”

Reference throughout this specification to “one embodiment,” “a first embodiment,” “an embodiment,” etc., means that a particular feature, structure or characteristic described in connection with the embodiment is included in at least one embodiment. Thus, the appearances of the phrases “in one embodiment,” or “in an embodiment” in various places throughout this specification are not necessarily referring to the same embodiment, or to all embodiments. Furthermore, the particular features, structures, or characteristics may be combined in any suitable manner in one or more embodiments to obtain further embodiments.

The headings are provided for convenience only, and do not interpret the scope or meaning of this disclosure.

The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not necessarily intended to convey any information regarding the actual shape of particular elements, and have been selected solely for ease of recognition in the drawings.

The present disclosure relates generally to a sensor and image processing system, such as may be used in an optical touch screen input device.

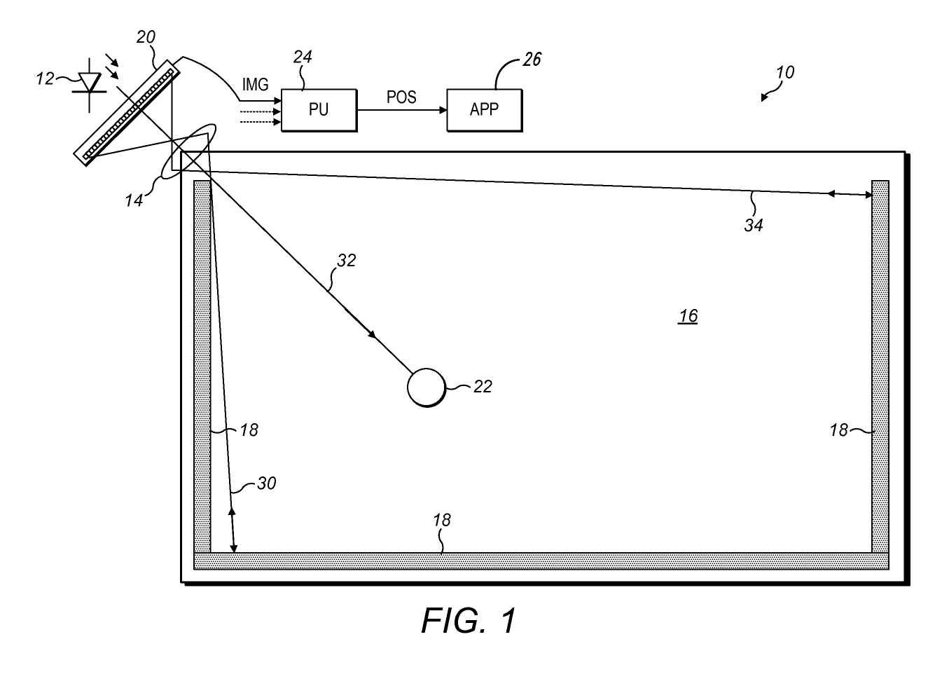

FIG. 1 shows schematically the principle of operation of a touch-screen 10 that is based on detection of reflected light at the edge to the screen. An LED light source 12 directs light (typically infrared radiation in practice) via optics 14 into the edge of a transparent panel 16 in front of a display such as an LCD display. The transparent display area of panel 16 is surrounded on three sides by retro-reflectors 18, formed for example from many corner-cube reflectors. Light reflected within the panel re-emerges through optics 14 to a linear image sensor 20. Image data IMG output by the sensor can be analyzed by a processor 24 to obtain position information POS for use in an application 26. The position information identifies a location 22 where an object such as a finger or stylus is touching the panel surface. For the sake of example, touch screen 10 may be combined with the display, processor 24 and application 26 in a single device such as a fixed or portable computer, personal communication device (smartphone), biometric device or the like. The screen can be small and portable or relatively large, for example covering a table-top display.

FIG. 1 shows three rays 30, 32, 34 for explaining operation. The central ray 32 hits object 22 (for example the user's finger and is absorbed and so no light is reflected to the sensor. The other two rays have no obstruction and so hit the retro-reflector and are reflected back along the same path and hit the sensor and are detected. Hence some pixels on the sensor receive light (e.g., nothing on the screen) while other pixels are dark as an object is obstructing the path.

FIG. 1 shows only a single sensor 20 for simplicity. Typically there will be multiple sensors so that (X,Y) data of the position of the touch can be accurately calculated. Image data IMG from the several sensors enters the processor 24 to be combined to obtain accurate position information about one or more objects 22. Retroreflectors can be provided in any distribution appropriate to the distribution of sensors and light sources. With just one additional sensor at the top right corner (as seen in FIG. 1), the same three sides having retroreflectors may be adequate. Where four or six sensors are distributed around the panel, retroreflectors may be provided along all four sides. Small apertures can be provided for the light and sensor beams, or the lights, sensors and reflectors may be stacked vertically so as not to obscure one another. FIG. 1 also shows the LED light source 12 displaced horizontally with respect to the sensor. Typically the LED and sensor will be co-located, but displaced in a vertical axis (such as, out of the page). Also for simplicity only a single optics 14 is shown for both the emitted and reflected light. There is typically separate optics for the LED and for the sensor. In other embodiments, the light sources and sensors are not positioned next to one another to operate by reflected light. They can be positioned on opposite sides of the panel so as to work by transmission of light across the panel.

It can also be seen in FIG. 1 that some optical paths are longer than the other and hence pixels corresponding to the longer path receive less illumination than those with the shorter path. This introduces challenges in the design of the sensor.

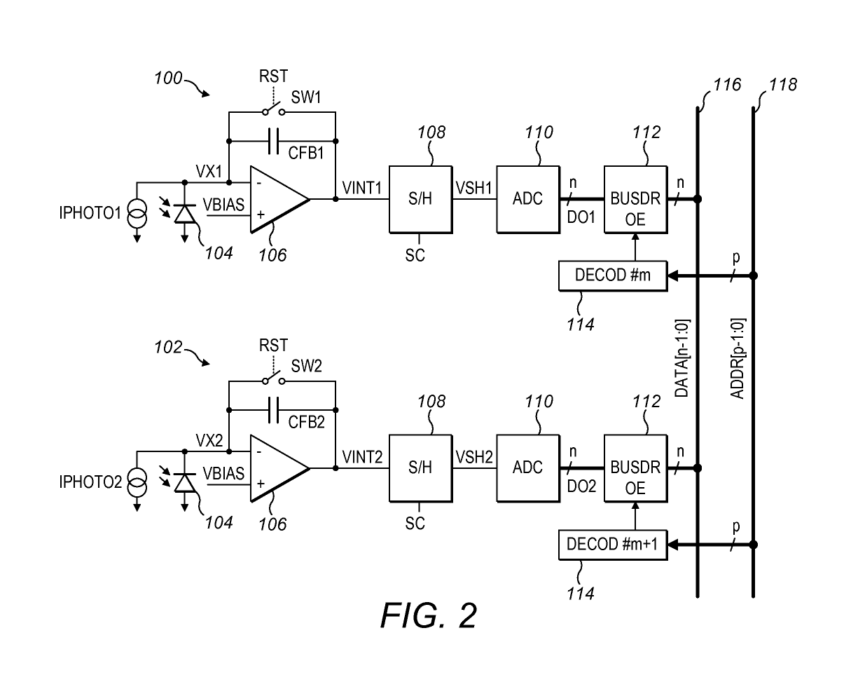

FIG. 2 shows a schematic circuit diagram illustrating the readout circuits 100, 102 for two pixels from a linear array of a known sensor 20. Each pixel circuit includes a photodiode 104, an integrator formed by operational amplifier 106 with respective feedback capacitors CFB1, CFB2, and respective reset switches SW1, SW2. Each pixel circuit further includes a sample and hold (S/H) circuit 108, and an analog to digital converter (ADC) 110, a bus driver 112 and a decoder 114. Data lines exit from the bus driver onto data bus 116. Addresses lines lead into the decoder from address bus 118.

The FIG. 2 circuit operates as follows. Light on each photodiode produces a current IPHOTO1 and IPHOTO2. The output from the photodiode is connected to an integrator formed by the operational amplifier with feedback capacitor CFB1, CFB2. Before the start of the exposure, the respective reset switches SW1, SW2 are closed by the reset signal RST. At the start of exposure the reset switches are opened and the operation of the operational amplifier combined with the CFB1 and CFB2 feedback capacitors is to accumulate the photo-generated charge onto the feedback capacitors. Hence the output voltage of the integrators VINT1 and VINT2 will increase during the exposure. The rate of increase of each voltage will depend on the photocurrent, and hence on the light level at the corresponding pixel. The rate of increase of VINT1 and VINT2 for a given photocurrent may be regarded as the integration gain of the pixel, and depends on the size of the capacitors CFB1, CFB2. At the end of exposure, the voltages VINT1 and VINT2 are stored by the sample and hold circuits in response to a sampling control signal SC and then, for convenience, converted into digital output values DO1, DO2 using the ADC. It will be appreciated that various types of ADC architectures could be used, these could include: single slope, cyclic, pipelined, sigma-delta, etc. The sampling function can be integrated into the ADC rather than providing a separate sample and hold circuit.

In a practical implementation, each photodiode may in practice comprise an array of sub-pixel photodiodes, connected in parallel. In some embodiments, the used photocurrent is taken from only a subset of the sub-pixels. One known use of this is to “trim” the line of the detector to compensate for a slight tilt in its mounting, relative to the panel. Each set or subset of these sub-pixel detectors is treated as a single photodetector for the purposes of the present disclosure. Further detail of this feature is not necessary here.

Typically all the pixels in a given array are exposed simultaneously. Subsequent operations such as sample and hold and ADC also occur simultaneously. The readout process is typically a sequential operation. A common method is to use a common data bus 116 [n−1,0] {n bit ADC} and enable the output of only one ADC at a time. The selection of which ADC is to be read at which time is typically controlled by using an address bus 118 [p−1,0], where p is the address bus width which enables 2̂p different pixels to be selected for being read (for example, if p=8 there are 2̂8=256 available pixel addresses). The above mentioned variable n defines the resolution of the ADC and allows 2̂n different values for DO1, DO2. Each pixel typically has its own decoder block (described further below) which is different for each pixel, such that only the output from a single pixel is enabled at any one time. The pixel that is read out is controlled by the address bus 118.

If IPHOTO1=10×IPHOTO2, then signal VINT1 will be 10×VINT2, similarly VSH1=10×VSH2 and the value DO1 is 10×DO2. If exposure control of the system ensures that VINT1 or VSH1 or DO1 is just less than the system's maximum, then the corresponding signals for the second pixel will be a tenth of the maximum, and this closer to the noise floor, which is undesirable. As mentioned in the introduction, it has been known to vary the conversion gain in the read-out process, so that darker pixels are boosted before being converted. However, the integration gain during the exposure time is constant across all pixels.

In most imaging applications, it is difficult to determine which pixels are brightly illuminated and which are darkly illuminated before the image is taken. Even if a further exposure is taken, which would enable the scene illumination to be determined, the effect would appear strange to the user. This is due to the fact that, changing the response (e.g., high and low) of a single pixel or a group or column of pixels is undesirable due to the boundary between high and low levels of response.

For machine vision applications such as touch screens, an aesthetic appearance is not important as the algorithms which processes the data can easily be adapted to ignore or compensate for these boundaries. However, this may require complex processing which could be costly and time consuming and which it may be desirable to avoid.

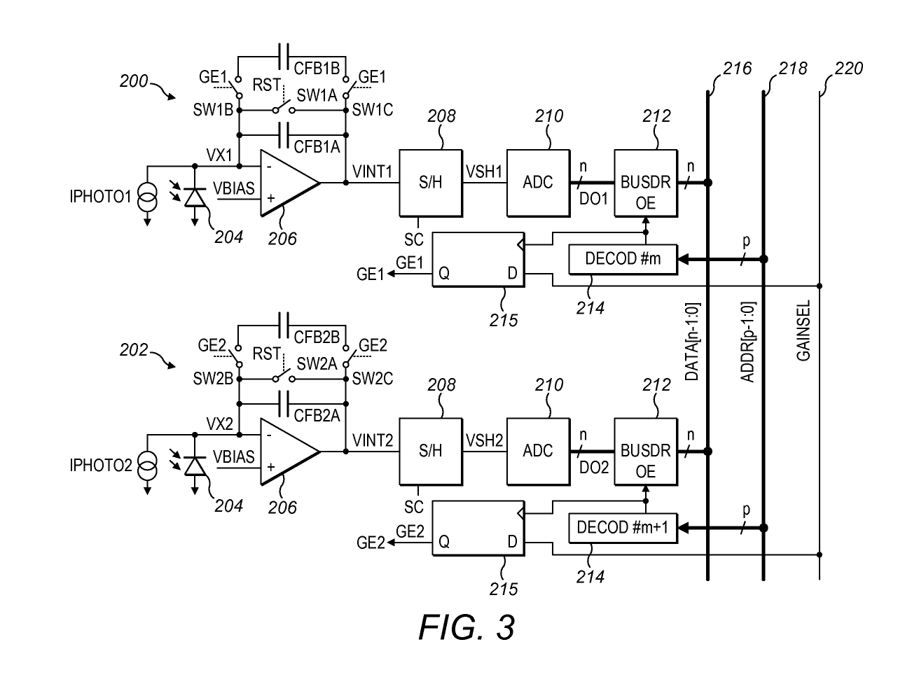

The present disclosure proposes to introduce variably responsive pixels by changing the integration gain of the pixel circuit using a switchable feedback capacitance. An embodiment of such a circuit will now be described with reference to FIG. 3.

In FIG. 3, readout circuits 200, 202 for two pixels are shown, which are similar in principle form to that shown in FIG. 2. Each pixel circuit includes: a photodiode 204; an operational amplifier 206; a sample and hold circuit 208; an analog to digital converter (ADC) 210; a bus driver 212; a decoder 214; and a latch 215. The data exits from the bus driver onto data bus 216. Addresses are fed to the decoder from address bus 218. In contrast to the known circuits, however, each pixel circuit 200, 202 now has two feedback capacitors, feedback capacitors CFB1A and CFB1B or CFB2A and CFB2B and three switches SW1A, SW1B and SW1C; and SW2A, SW2B, and SW2C. Switches SW1A and SW2A are reset switches with the same function as in the known circuit. Switches SW1B/SW2B and SW1C/SW2C are provided to switch the second capacitor CFB1B/CB2B in or out of the circuit. The additional switches are connected to receive a gain enable signal GE1, GE2 from latch 215. A gain selection bus 220 sends a control signal GAINSEL to the latch 215.

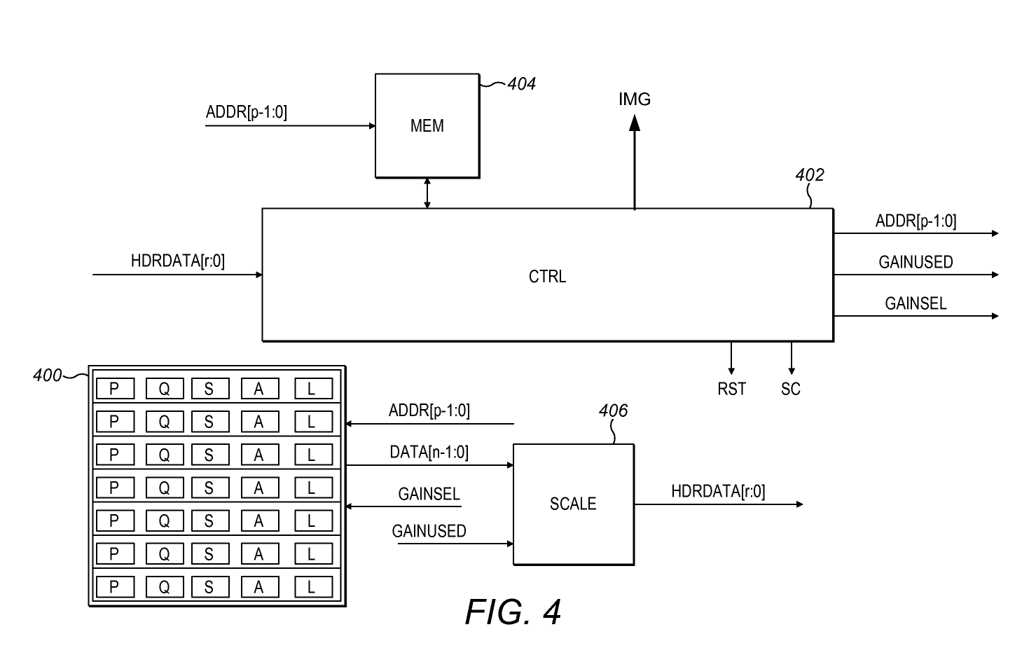

FIG. 4 is a block diagram of the electronics of the touch panel as a whole, in an example embodiment. There is an array 400 of pixel circuits, which may for example be of the same form as the two pixel circuits shown in FIG. 3. Each pixel circuit comprises a photodiode (P), charge integrator (Q), optional sample and hold (S) and analog-digital convertor (A) and logic (L). These correspond to the elements 204-212 shown in more detail in the pixel circuits of FIG. 3. The array of pixel circuits communicates with a control block 402 and memory 404 via the address and data bus lines shown. There is also a scaling block 406, which may be integrated into the control block. Memory 402 in one embodiment is used to store the gain selected for each pixel. The image data itself is not stored in this embodiment, but passed out to a processing unit (see PU 24) synchronously with being read out from the pixel circuits. This may be a separate memory block or integrated into the control block. All these blocks may be integrated on a single substrate, or it is possible to have a multi-chip solution where the pixel array is on one substrate and the other blocks on other(s). In a single-chip solution, the electronics of the touch panel may be integrated with other functions of a target device, for example a personal computer, PDA, communication handset and the like.

In operation, control block 402 generates numerous timing signals, addresses and the like, to control the operation of the sensor frame-by-frame, and pixel by pixel within frames. On a frame-by-basis, the control block outputs the signal RST that resets the integrators in all the pixels simultaneously. When the reset signal is released, an integration time interval begins. The control block also outputs the sample and hold control signal SC that triggers the sampling of integrator voltage VINTx in all pixels simultaneously. Within each frame addressing and gain selection signals are generated to read out the digitized pixel values for each pixel, and to set variable gains per pixel, as desired. It will be described how readout and gain setting can be performed in one addressing cycle. In other embodiments, separate cycles might be provided for readout and gain selection.

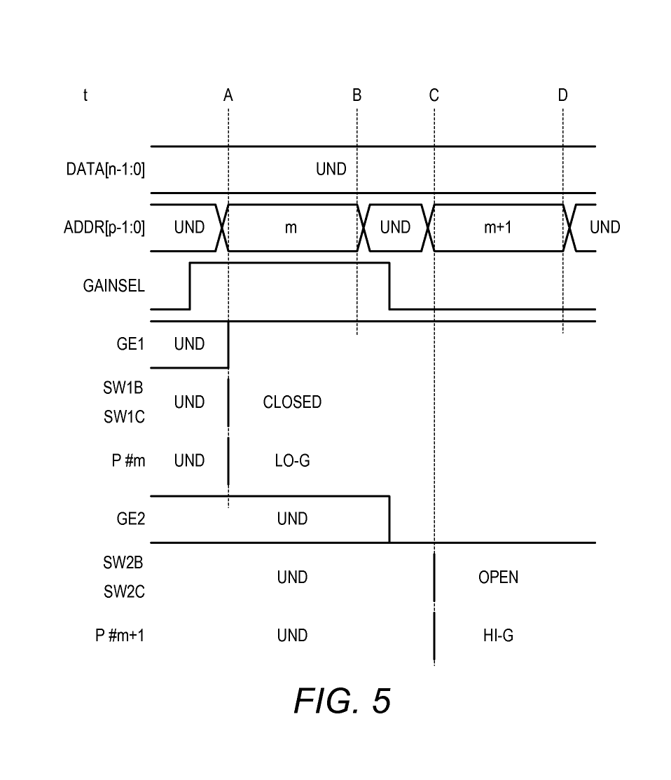

An example of the operation of the FIGS. 3 and 4 circuit on a per-pixel basis will now be described in more detail, with reference also to the timing diagram of FIG. 5. In the case of the first pixel 200, capacitor CFB1A is always connected across the operational amplifier. Capacitor CFB1B is only connected when switches SW1B, SW1C are closed. Typically these switches may be implemented using MOS transistors or preferably using CMOS transmission gates. The gain enable signal GE1 is used to control whether these switches are open or closed. Similarly in the second pixel, capacitor CFB2A is always connected, while capacitor CFB2B is only connected when switches SW2B, SW2C are closed. The gain enable signal GE2 controls these switches so that the gain of the second pixel can be set high or low, independently of the gain setting of the first pixel.

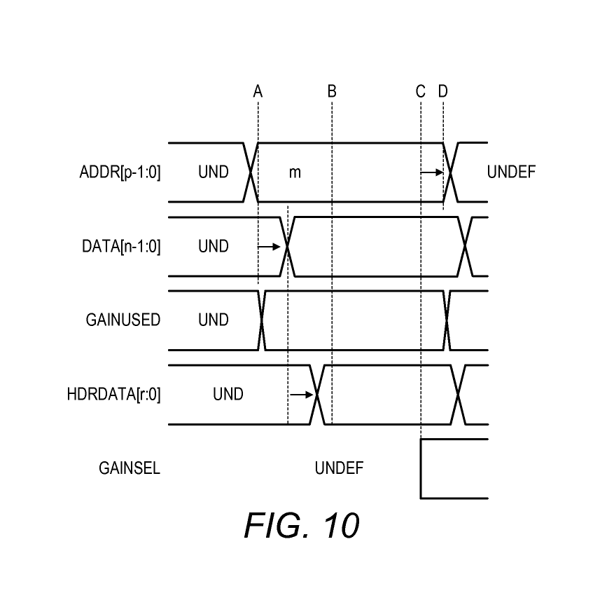

The address bus 218 now serves two functions. Firstly the bus is used to selectively enable the output of a single pixel as described above with reference to FIG. 2. Secondly the bus 218 can also be used to cause gain selection latch 215 to store the current value of gain selection signal GAINSEL in a particular pixel. Referring to the illustrative timing example of FIG. 5, at time A the control block sets “GAINSEL” high and then ADDR[p−1:0] to #m. The decoder block 214 of the first pixel 200 goes active and the “GAINSEL” high logic value is stored in the latch 215 of pixel 200 and so GE1 goes to logic high level, closing the switches SW1B and SW1C. (This timing diagram shows only the setting of pixel's GAINSEL lines. Typically, this is done as part of the pixel readout and such operation is described in FIG. 10.)

Shortly afterwards, “GAINSEL” may for example be set low and then ADDR[p−1:0] set to #m+1. In response, at time C the decoder block 214 of the second pixel 202 goes active and the “GAINSEL” low logic value is stored in latch 215 of pixel 202. GE2 goes low, thereby opening the switches SW2B and SW2C.

As a result of this example operation, the feedback capacitance of pixel 200 is CFB1A+CFB1B while the feedback capacitance of pixel 202 is only CFB2A. Pixel #m is thus set to a low gain condition. Pixel #m+1 is set to a high gain condition.

Assuming that like capacitors each have the same value, for example for CFBxA the capacitance is 10 fF and for CFBxB the capacitance is 90 fF, pixel 200 will have a feedback capacitance of 100 fF and pixel 202 will have a feedback capacitance of 10 fF. As a result of these different capacitances, the gain of the integrator for the second pixel will be ten times that of the first pixel. This increased gain for the second pixel (relative to the first pixel) is achieved while the integration time for both pixels remains the same. Consequently, when IPHOTO1=10×IPHOTO2, the integrated signal VINT1 will the same as VINT2. Similarly VSH1 will equal VSH2 and the value DO1 in ADC 210 of pixel 200 will be the same as DO2 in ADC 210 of pixel 202.

Assuming the exposure control circuit of the overall system adapts the exposure to facilitate the output from pixel 200 being near to saturation, then using the increased gain, the output from pixel 202 will also be near to saturation. This is generally much higher than using known technique and so there can be fewer problems with proximity of the noise floor, that is a higher SNR.

FIG. 3 shows the use of two switches SWxB and SWxC around the additional feedback capacitance for symmetry. If space on the device was critical, one of these switches, for example switch SWxB at the input of the operational amplifier, could be omitted to save space.

The ratios of the feedback capacitance can be selected by the user depending on the requirements of the system and circuit. A ratio of 1:1 allows a variation in conversion gain of 1:2. A ratio of 1:3 would permit a variation in conversion gain of 1:4. Other ratios are also possible.

To understand how switching the capacitors can change the gain of a pixel circuit, consider the relationship between a constant current, capacitor, voltage and time is shown in Equation 1.

I=C*dV/dt (1)

Equation 1 can be rearranged to define the voltage V as shown in Equation 2:

dV=I*dt/C (2)

Applying these equations to photo-detectors of the types illustrated in FIGS. 2 and 3, I is the photocurrent IPHOTO and is substantially proportional to the amount of light impinging on the pixel. The “integration time” dt is a measure of how long the photocurrent is collected for (the time between the pixel's reset and readout) and the capacitance “C” depends on the pixel architecture. The output signal of a pixel is represented by voltage V, that is the voltage on the integrator capacitor.

For examples with small pixel areas (e.g., <5 μm×5 μm) pixels, capacitance C is usually simply the capacitance of the photodiode or sense node. This is set by the design and manufacture of the device and is not typically variable. With larger pixels, or a linear array, there is room to have more circuitry, for example implementing a charge integrator formed from an amplifier with a feedback capacitor as shown in FIG. 3. In this case, the “C” in Equations 1 and 2 is primarily the capacitance of the feedback capacitor.

For a given amount of light, I is fixed and so typically the integration time is varied to give a suitable voltage swing (higher than the noise floor, but not so high that the voltage saturates). Of course there are limitations on the range of integration values—for example on a hand-held imaging system, this is typically 1/30 seconds (33 ms) which is typically as long as a user can hold a camera still. For a touch sensor system such as the one illustrated in FIG. 1, it is important to minimize the latency (time from a touch until it is reported), and so shorter integration times for example 1 ms are typically used.

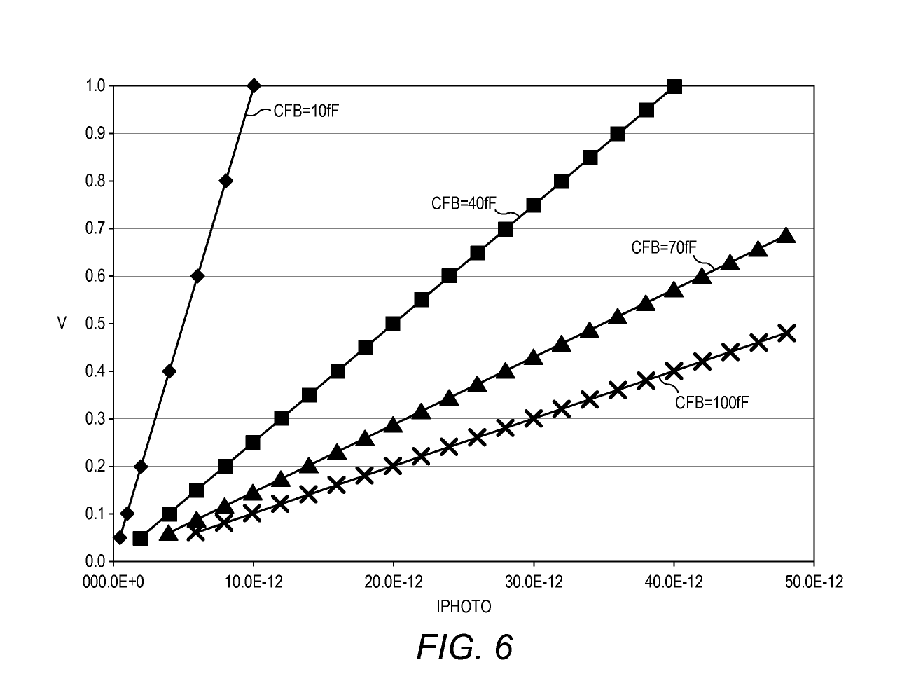

FIG. 6 shows graphs of voltage against photocurrent in an example pixel circuit. Each line shows the voltage swing V at the output of the charge integrator (106) for different photocurrents (light levels on the pixel) and different values of feedback capacitance CFB. The steepness of the graph indicates the gain of the integrator. The integration time dt is 1 ms in all cases shown in FIG. 6. In this example, we assume that there is a noise floor of 50 mV such that voltage swings below this value are inaccurate and are not plotted. Similarly there is a maximum swing of 1V and signal swings above this value are assumed to be saturated and also not plotted. The value of photocurrent IPHOTO is plotted from zero at the left to 50 pA at the right hand side.

The graphs shows that for photocurrents less than about 10 pA, CFB=10 fF is the most suitable. The steepness of the graph maximizes the signal swing (hence improving signal-noise ratio), but after 10 pA, a readout with this feedback capacitance would saturate. For photocurrents greater than 10 pA but less than 40 pA, a feedback capacitance of 40 fF might be appropriate. For photocurrents from 40 pA to 70 pA a feedback capacitance of 70 fF is suitable and from 70 pA to 100 pA a feedback capacitance of 100 fF is suitable. With this configuration, photocurrents of greater than 100 pA will cause saturation, even with the lowest gain.

FIG. 6 illustrates that, by providing two or more different capacitance values that can be selected, the appropriate gain for each pixel can be selected. This results in an increase of the dynamic range of the pixel array as a whole. A conventional sensor that has only 10 fF feedback capacitance would operate from 0.5 pA (the signal is the same as the noise floor) to 10 pA (system clips), a dynamic range of 20:1. However, if the pixel circuits can switch gains, so that every pixel can operate between 0.5 pA (noise floor with feedback capacitance of 10 fF) and 100 pA (saturation with 100 fF feedback capacitance), a dynamic range of 200 can be provided.

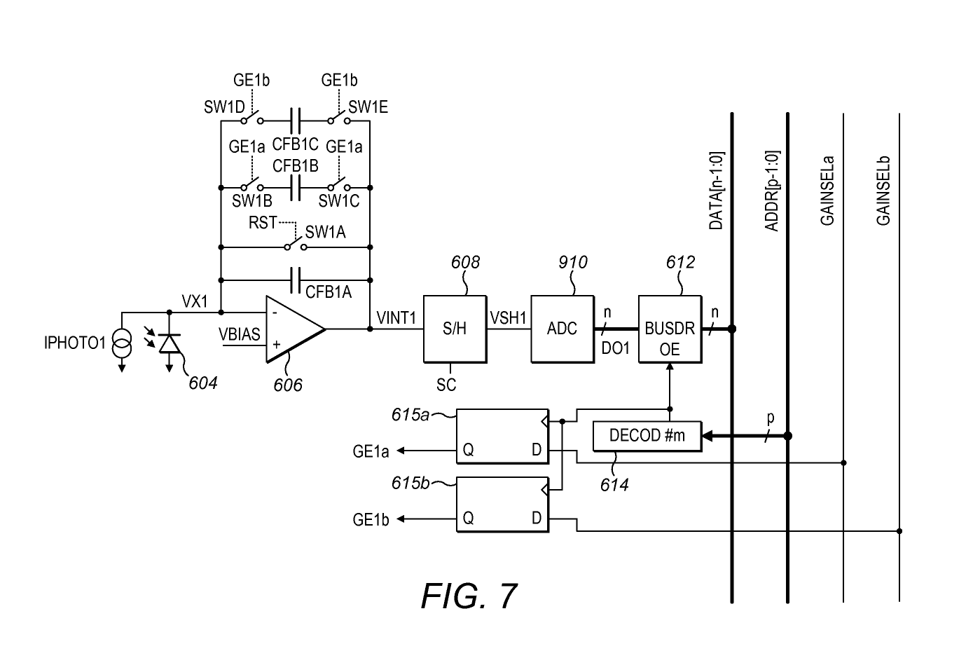

While FIG. 3 shows pixel circuits with two different gain values selectable, the technique can be easily extended to include a greater number of switchable feedback capacitors for each pixel. This would give a finer control of the conversion gain at the expense of more digital logic in the pixel and more bits on the gain selection bus GAINSEL. For example, FIG. 7 shows a pixel circuit with three selectable gains. Elements 604 to 614 correspond exactly to the elements 204-214 in the first pixel circuit of FIG. 3. Instead of a single bit gain enable signal and a single latch 215, there are now two gain enable signals GE1a and GE1b which are set using two corresponding gain select buses GAINSELa and GAINSELb. In addition to the capacitors CFB1A and CFB1B, a third capacitor is provided. Capacitor CFB1A is (in this example) permanently connected to the operational amplifier 606. Capacitor CFB1B is connectable by operation of switches SW1B, SW1C under control of the first gain enable signal GE1. Capacitor CFB1C is connectable by closing switches SW1D and SW1E under control of the second gain enable signal GE1b. Thus using a two-bit gain setting, three different gains can be set. With the switching network and three capacitors as shown, four gain settings can be selected per pixel.

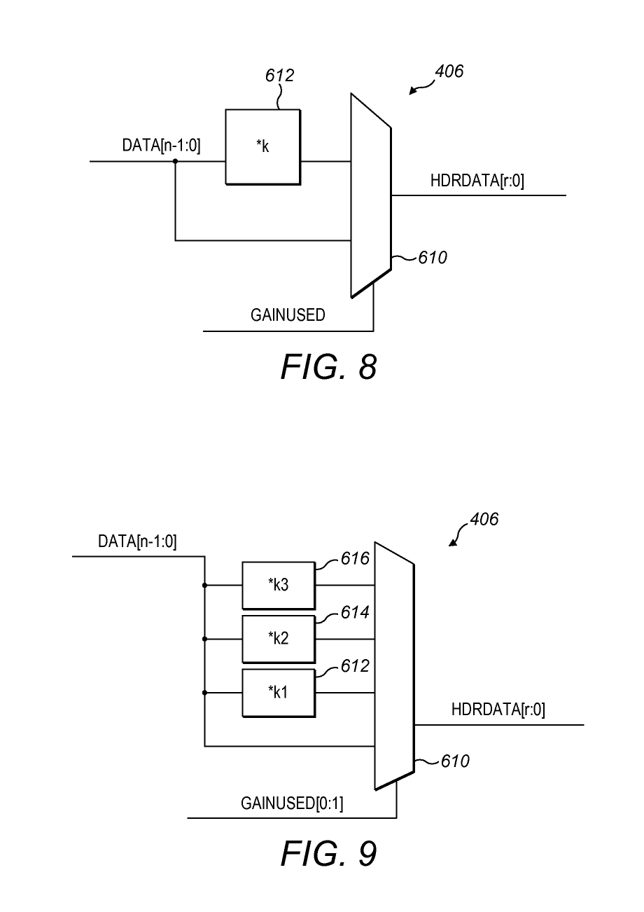

Referring now to FIGS. 8 and 9, these show embodiments of the scaling block 406. This block is optional, but it may be desirable for subsequent processing that all pixels produce comparable data, even if they don't have the same conversion gains. The scaling block 406 can be included as one way to achieve this in the hardware. FIG. 8 shows one possible implementation for the case with two possible gains for a pixel (for example the FIG. 3 pixel circuits) while FIG. 9 shows an implementation suitable where there are three or four possible gains for a pixel (enhanced version of FIG. 6).

In each scaling block, the n-bit data DATA[n−1:0] from the analog-digital converter is delivered to a multiplexer 610 and also to a digital multiplier circuit 612 which multiplies the data by a pre-defined value “k”. An output of the multiplexer comprises high dynamic range data HDRDATA[r:0] where r>n−1. The multiplexer is controlled to select one or other of the inputs, in accordance with a signal GAINUSED that records which gain setting was when that pixel recorded a level of illumination. If the pixel used the low feedback capacitance (high conversion gain), then the data is passed directly to the output as high dynamic range data. This operation can be expressed in the form HDRDATA[r:n]←0, HDRDATA[n−1:0]←DATA[n−1:0], which includes setting the higher order bits which should be set to 0.

When the pixel value DATA that has been recorded used the high feedback capacitance (low conversion gain), then the data DATA[n−1:0] is to be multiplied by the constant, k, and the other input of the multiplexer is selected. In this operation, HDRDATA[r:0]=k*DATA[n−1:0]. The value of k is the ratio of the conversion gains defined by the capacitances CFB. For example, (CFBxA+CFBxB)/CFBxA.

A similar method can be used for three, four or more gains, as illustrated in FIG. 9. Here multiplexer 610 has four data inputs, and multipliers 612, 614, 616 with different multiples of k are provided. Again, when the conversion gain is the highest (lowest feedback capacitance) the ADC data is not multiplied, otherwise the ADC data is multiplied by the ratio of conversion gains.

The following table (TABLE 1) illustrates a possible set of conversion factors k1, k2, k3 based on permutations of the capacitance values mentioned for the graphs of FIG. 5. The capacitors can be provided in four combinations, giving four different conversion gains.

TABLE 1

| | Feedback | Conversion | |
|---|---|---|---|
| GAINUSED[1:0] | Capacitance | Gain | k |
| 00 | 10 fF (CFB1A) | 16 μV/ | 1 |
| | | electron | |
| 01 | 40 fF (CFB1A + | 4.0 μV/ | k1 = 4 (40/10) |
| | CFB1B) | electron | |
| 10 | 70 fF (CFB1A + | 2.3 μV/ | k2 = 7 (70/10) |
| | CFB1C) | electron | |
| 11 | 100 fF (CFB1A + | 1.6 μV/ | k3 = 10 (100/10) |
| | CFB1B + CFB1C) | electron | |

As the implementation of digital multipliers require a significant amount of silicon area, it may be preferable to ensure that the capacitance gains are related by integer powers of 2, such as, *1, *2, *4, *8. If this is adopted, then the gain can be achieved by shifting the data rather than using a multiplier, as shown in TABLE 2.

TABLE 2

| k | HDRDATA |
|---|---|
| 1 | HDRDATA[r:n] ←0 ; HDRDATA[n − 1:0] ←DATA[n − 1:0] |
| 2 | HDRDATA[r:n + 1] ←0 ; HDRDATA[n:1] ←DATA[n − 1:0]; |
| | HDRDATA[0] ←0 |
| 4 | HDRDATA[r:n + 2] ←0 ; HDRDATA[n + 1:2] ←DATA[n − 1:0]; |
| | HDRDATA[1:0] ←0 |
| 8 | HDRDATA[r:n + 3] ←0 ; HDRDATA[n + 2:3] ←DATA[n − 1:0]; |
| | HDRDATA[2:0] ←0 |

As different pixels have different conversion gains, the timing of the pixel readout and output scaling gain correction may be controlled.

FIG. 10 shows suitable pixel read timing of an embodiment. This shows timing for one pixel (pixel #m), it being understood that many such cycles are performed in sequence, so as to read all the pixels of the array 400. For systems such as touch screens, it may be important to retain temporal fidelity, e.g., all pixels capture light simultaneously, all pixels convert charge simultaneously and the sample and hold circuits operate substantially simultaneously. In the architecture proposed, this is easy to achieve by ensuring that the RST signal is common to all pixels thereby ensuring that they all integrate and convert simultaneously. Similarly there is a common control signal for each pixel's sample-and hold circuit, which ensures that these circuits operate substantially simultaneously.

At time “A”, the control block 402 outputs the pixel number (m) on the address bus (ADDR[p−1:0]). It also sets the GAINUSED line to the appropriate level. (Where more than two gain levels are selectable per pixel, then signal GAINUSED, like signal GAINSEL, will have two or more bits.) Typically, the control block will have memory 404 which stores the value of the gain used for each pixel, that is to say, the gain set prior to exposure to the light being measured. In an alternative embodiment to be described below, the gain may be set autonomously by each pixel, and the signal GAINUSED is provided by the pixel.

Setting the address bus will cause the appropriate pixel's output buffer (bus driver 212/412) to be enabled and a short time later the digital signal value output by ADC 210/610 value will be output on the DATA[n−1:0] bus. This data value will be scaled by the scaling block 406 and a short time later, at time “B” the r-bit HDRDATA bus will have the scaled value.

Some time on or after point B, the control block will read the HDRDATA bus. In one embodiment, the control block will examine the value of the HDRDATA and the GAINUSED and compare these to appropriate thresholds to decide if the pixel gain used in this exposure is suitable for the next exposure on this pixel, or a different pixel gain value is required for the next exposure. The next gain selection value can be stored in memory 404 and/or it can be written directly into the latch 215 of the relevant pixel. In this case, at time “C” the control block sets “GAINSEL” line(s) are pixel gain for the next exposure and this is stored in the pixel's logic.

The control block then waits a short time (propagation delay) to allow the GAINSEL value to be correctly stored in the pixel and then at time “D” the sequence can be repeated for the next pixel ADDR=m+1.

An example algorithm for determining pixel gains based on past values is now presented in pseudo-code. The scaled data is compared with thresholds in a manner similar to that described already with reference to the graphs of FIG. 6. The symbol # in the pseudo-code listing represents an explanatory comment. Depending on the current value of GAINUSED[1:0], one of four cases is applied:

```
Case GAINUSED = 0: # Lowest capacitance → highest conversion gain
      If HDRDATA > THRESH_High0 then
      GAINSEL ← 1
    # Avoid pixel clipping by increasing feedback capacitance for next
                            exposure
      Endif
    # If HDRDATA less than threshold, then keep the same
    # There is no lower capacitance (higher gain), increase the
                            exposure (integration time) for the
                            whole array if necessary.
Case GAINUSED = 1:
      If HDRDATA < THRESH_Low1 then
      GAINSEL ← 0
    # Data low, so getting close to noise floor. Reduce capacitance
                            and increase gain to improve SNR
      Endif
      If HDRDATA > THRESH_High1 then
      GAINSEL ← 2
    # Avoid pixel clipping by increasing feedback capacitance for next
                            exposure
      Endif
      # If HDRDATA between thresholds, then keep the same
Case GAINUSED = 2:
      If HDRDATA < THRESH_Low2 then
      GAINSEL ← 1
    # Data low, so getting close to noise floor. Reduce capacitance
                            and increase gain to improve SNR
      Endif
      If HDRDATA > THRESH_High2 then
      GAINSEL ← 3
    # Avoid pixel clipping by increasing feedback capacitance for next
                            exposure
      Endif
    # If HDRDATA between thresholds, then keep the same
Case GAINUSED = 3: # Highest capacitance → lowest conversion gain
      If HDRDATA < THRESH_Low3 then
      GAINSEL ← 0
  # Data low, so getting close to noise floor. Reduce capacitance
                            and increase gain to improve SNR
      Endif
    # If HDRDATA above low threshold, then keep the same - there is
                            no higher capacitance (lower gain),
                            reduce exposure for whole array if
                            necessary.
```

In addition to or as an alternative to the continuous updating of gain values proposed above, values may be measured as part of a calibration process and then left relative unchanged for normal operation. The values may even be preprogrammed entirely, based on knowledge of the relative light levels at each pixel. For example, in the touch panel example, it may simply be known that a middle third of the pixels are generally darker than the outer thirds, because of the length of light path to the retroreflector at the opposite corner of the panel. The system could be preprogrammed to set the middle third of pixels with high gain. This high gain may be constant, or it may be only an initial state prior to more automatic adjustment using methods such as those described above.

In one embodiment the sensor system that calibrates itself on power on, various procedures can be envisaged. One procedure would be to start with low gain (high feedback capacitance) on all pixels, take an image and then see which pixels are dark and then switch these to high gain (low Cfb). This could be a power-on only, or possibly more often. If the system detected a pixel has a low value for a period time, it could be switched into a high gain mode.

The logic shown in FIG. 3 and explained above is relatively straightforward. When the pixels are read out, the logic value on the “GAINSEL” bus is also stored. This could be advantageous as it allows the response of the pixel for the next exposure to be set at the same time as readout for the current image. Note that in the above example, each case of GAINUSED has its own threshold—this is because the input values is HDRDATA (e.g., gain scaled) and so the pixel's operating level (e.g., below the noise floor or close to/above saturation) cannot be determined by HDRDATA alone, it is necessary to include GAINUSED to determine if the pixel is close to the noise floor or to saturation. If the DATA bus (e.g., un-scaled data) is available, then typically the thresholds for changing gain will be independent of the GAINUSED setting as the noise floor and saturation levels are a function of voltage swing (and consequently ADC output data DATA). This can be exploited to implement a simple automatic gain adjustment that is effectively performed locally to each pixel.

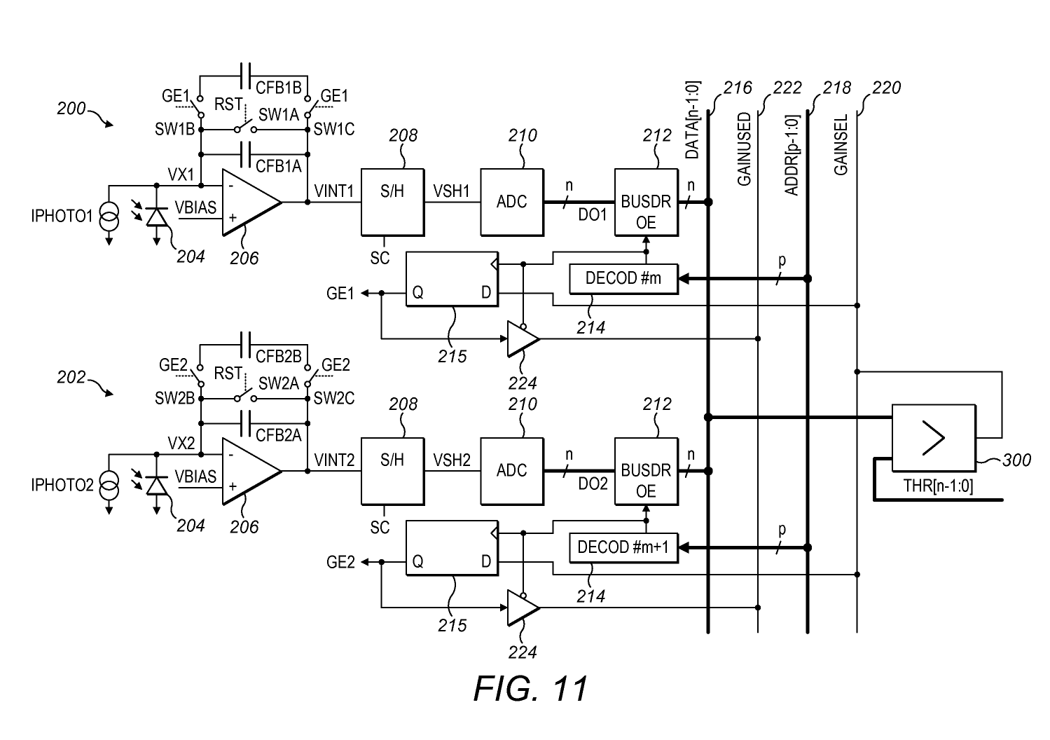

FIG. 11 shows a circuit in which such local automatic setting of the gain is enabled. When a pixel is read, its digital output is compared to a threshold using a logic gate to provide a “less than” signal. This signal is fed back into the latch of the pixel, so as to control the feedback capacitance for the next exposure.

FIG. 11 is similar to FIG. 3 and common elements are given the same names and references as in FIG. 3. The description of common elements is not repeated with respect to FIG. 11. FIG. 11 includes a threshold circuit 300 which is connected to the data bus 216 and the GAINSEL bus 220.

Further enhancements can be provided to the scheme shown in FIG. 3 by using more sophisticated logic. For example, if there were two thresholds, then a hysteresis behavior could be added. If data is less than a first threshold, call it THR1, then gain increases and capacitance reduces. If data is greater than a second threshold, THR2, the result is reduced gain and increased capacitance.

Further, in FIG. 11, the signals GEx (GE1 and GE2) that identify the gain used would remain inside each pixel circuit if they are not communicated outside of the pixel. If the automatic gain selection method is used, then it is advantageous to read out the signal GEx to obtain signal GAINUSED when the pixel is being read out. This is enabled in the illustrated circuit by providing a separate data bus 222, labeled GAINUSED. The readout of the gain used is done using the same output enable (OE) signal and an extra single-bit bus driver 224. This GAINUSED signal can be stored in memory 404 and/or used by scaling block 406 to enhance the dynamic range. If it is undesirable for the operation of writing the conversion gain to occur at the same time as readout of the pixel, it is easily prevented by adding a separate global control signal (not shown) and modifying the logic in each pixel so that the storage of “GAINSEL” is only activated when this global control signal is active. This global control signal could then de-activate again during pixel read.

In all the above examples, the sensor may be of any appropriate type and may be for example a CMOS sensor having an array of pixels for measuring light at different locations. The sensor may be used for many different linear or two-dimensional imaging applications. In the touch panel application as described above the pixels are used to measure illumination influenced by a touch at one or more points on the panel. While a linear (1-D) array of pixels and pixel circuits is illustrated and described above for use in a touch screen application, the principles of variable gain can be applied also in two-dimensional arrays. The illumination source may be of any appropriate type, such as one or more light-emitting diodes (LEDs), a laser diode such as a vertical cavity surface emitting laser (VCSEL) or any other appropriate type of illumination and may generate a source in the “visible” (wavelengths 400 nm-680 nm) or non-visible ranges. Accordingly, reference to optics and optical are intended to cover wavelengths which are not in the human visible range.

Some or all of the functions or modules could be implemented in software. It will be appreciated that the overall sensor and imaging function and methodology could be either software, hardware or any combination thereof.

Some embodiments may take the form of or include computer program products. For example, according to one embodiment there is provided a computer readable medium including a computer program adapted to perform one or more of the methods or functions described above. The medium may be a physical storage medium such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some of the systems and/or modules and/or circuits and/or blocks may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The combined touch screen sensor and image processing method may be used in many different environments in an appropriate device, for example a television; a computer or other personal digital assistant (PDA); a phone; an optical pushbutton; entrance and exit systems; and any other touch screen on any other device. The functions of such a device are well known to the skilled person and are represented in FIG. 1 simply by the application block APP.

It will be appreciated that there are many possible variations of elements and techniques which would fall within the scope of the present invention, in addition to the examples and variations described above.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A device, comprising:
a plurality of pixels, each pixel including:
a light-sensitive photodetector; and
circuitry configured to set a pixel gain of the pixel and to accumulate photo-generated charge from the light sensitive photodetector, wherein the plurality of pixels are configured to accumulate photo-generated charge substantially simultaneously using different pixel gains for different pixels of the plurality.

2. The device of claim 1 wherein each pixel comprises an integrator to integrate a photocurrent received from said photodetector over a sampling interval that is substantially the same in the pixels of the plurality, the setting of the respective pixel gains of the pixels of the plurality being implemented by selecting a capacitance within said integrator.

3. The device of claim 1 wherein the pixel gain of a pixel of the plurality is variable over time.

4. The device of claim 3 wherein circuitry of a pixel of the plurality is configured to set the pixel gain by switching one or more capacitors in and out of an integrating circuit.

5. The device of claim 1 wherein a pixel of the plurality is coupled to an address bus and a data bus and is configured to, in a data read-out cycle:
provide a pixel output signal; and
store a pixel gain selection signal.

6. The device of claim 1 wherein pixel output signals are read out from the pixels in a read cycle using an address bus and a data bus, and a gain-used signal is read out of each pixel as part of the read cycle.

7. The device of claim 1 wherein the device is configured to select a gain of each pixel of the plurality automatically in response to data obtained from the respective pixel in one or more previous operations.

8. The device of claim 1, comprising a scaling module configured to convert data from the pixels of the plurality of pixels to a common scale.

9. The device of claim 1 wherein said plurality of pixels are arranged in a linear array.

10. The device of claim 1 wherein the circuitry configured to set the pixel gain of a respective pixel is configured to set the pixel gain independent of the pixel gain of other pixels of the plurality of pixels.

11. The device of claim 1 wherein the gain of a subgroup of pixels of the plurality is set for the subgroup.

12. A system, comprising:
a sensor;
an illumination source configured to illuminate the sensor via a medium to be monitored; and
a processor configured to generate object position information using image data provided by the sensor, the sensor including a plurality of pixels, each pixel having:
a light-sensitive photodetector; and
circuitry configured to set a pixel gain of the pixel and to accumulate photo-generated charge from the light sensitive photodetector, wherein the plurality of pixels are configured to accumulate photo-generated charge substantially simultaneously using different gains for different pixels of the plurality of pixels.

13. The system of claim 12 wherein said medium comprises a transparent touch panel, the system being configured to sense, using illumination provided from an edge of the panel, a position of a touch to the panel.

14. The system of claim 12, comprising a plurality of sensors including the sensor, the plurality of sensors being configured to sense the medium from different directions, the processor being configured to combine signals from the plurality of sensors to generate the object position information.

15. The system of claim 12 wherein the medium is a transparent touch panel of a display.

16. The system of claim 15 wherein the display is a personal computer or communication device display.

17. The system of claim 12 wherein the circuitry of a pixel of the plurality is configured to set the pixel gain of the pixel by switching one or more capacitors in and out of an integrating circuit of the circuitry.

18. A method, comprising:
setting a pixel gain of each pixel of a plurality of pixels of a sensor, each pixel of the plurality including a light-sensitive photodetector and pixel circuitry configured to set the pixel gain of the pixel; and
accumulating photo-generated charge from the light sensitive photodetectors of the plurality of pixels substantially simultaneously using the respective pixel circuitry and different pixel gains for different pixels of the plurality of pixels.

19. The method claim 18, comprising updating the set pixel gains automatically in response to previously generated signals of the pixels.

20. The method of claim 18 wherein,
accumulating photo-generated charge in a pixel of the plurality comprises integrating in an integrator of the circuitry of the pixel a photocurrent received from the photodetector of the pixel over a sampling interval, the sampling interval having substantially a same duration in the pixels of the plurality; and
setting the pixel gain of a pixel of the plurality comprises switching one or more capacitors in and out of the integrator.

21. The method of claim 18 wherein a pixel of the plurality is coupled to an address bus and a data bus and the method includes, in a data read-out cycle:
providing by the pixel circuitry of a pixel output signal; and
storing of a pixel gain selection signal.

22. The method of claim 21 wherein a gain-used signal is read out of each pixel as part of the data read-out cycle.

23. The method of claim 18, comprising converting data from the pixels of the plurality of pixels to a common scale.

24. The method of claim 18, comprising:
illuminating a medium of the sensor; and
generating object position information using image data provided by the sensor.

25. The method of claim 24 wherein said medium comprises a transparent touch panel, the position information is a position of a touch to the panel and the illumination is provided from an edge of the panel.

26. The method of claim 23, comprising:
reading signals from the sensor and from one or more additional sensors, wherein the generated object position information is based on the signals read from the sensor and from the one or more additional sensors.

27. A device, comprising:
a plurality of pixels, each pixel including:
a light-sensitive photodetector; and
circuitry configured to independently set a pixel gain of the pixel and to accumulate photo-generated charge from the light sensitive photodetector, wherein the plurality of pixels are configured to accumulate photo-generated charge substantially simultaneously using the respective independently set pixel gains.

28. The device of claim 27 wherein the pixel gain of a pixel of the plurality is variable over time.

29. The device of claim 28 wherein circuitry of a pixel of the plurality is configured to set the pixel gain by switching one or more capacitors in and out of an integrating circuit.
